(19) United States
(12) Patent Application Publication
(10) Pub. No.: US 2022/0334281 A1
(43) Pub. Date: Oct. 20, 2022

(54) OCEAN BOTTOM SEISMIC NODE SYSTEM

(71) Applicant: MAGSEIS FAIRFIELD ASA, LYSAKER (NO)

(72) Inventors: Bjørn JENSEN, HASLUM (NO); Per Christian GRYTNES, BILLINGSTAD (NO); Magnus LINDBERG, FIGGJO (NO); Oddbjørn GRAVDAL, STAVANGER (NO); Sebastian SOLLI, STAVANGER (NO)

(21) Appl. No.: 17/633,987

(22) PCT Filed: Jun. 18, 2020
(86) PCT No.: PCT/NO2020/050167

§ 371 Date: Feb. 9, 2022

(30) Foreign Application Priority Data
Aug. 13, 2019 (NO) 20190977

(51) Int. Cl. G01V 1/38; B63G 8/00

(52) U.S. Cl. CPC G01V 1/3852; B63G 8/001; G01V 1/3835; B63G 2008/005

(57) ABSTRACT

There is described a system for deploying and retrieving seismic nodes on the seabed. The system uses a modular container that can be connected to a ROV. The container includes a magazine for storing a number of individual nodes, as well as having means for moving the nodes through the magazine onto the seabed.

### INTRODUCTION

The present invention relates to the field of marine seismic exploration. More particularly, the invention relates to a system for deploying and retrieving seismic nodes from an ROV.

### BACKGROUND

A seismic survey at sea involves firing an array of acoustic sources at a known position. Acoustic waves travel through the water into a subterranean formation, where they are reflected and refracted from various layers in the formation. The reflected and refracted waves are detected and recorded for later analysis in order to provide information about the subterranean structure or formation.

In order to detect as much as possible of the reflected and refracted waves, seismic sensors such as geophones have to be planted in close acoustic contact with the seafloor, and hydrophones in a position just above the seafloor. The seismic sensors are conventionally arranged in seismic nodes, each node comprising one or more seismic sensors.

During recent years, there has been an increased effort to improve the results of marine seismic investigations by collecting seismic signals at the ocean bottom instead of using the more usual vessel towed hydrophones for signal recording. There are basically two principal methods that are used at present for collecting seismic data using seismic sensors. The first method is to deploy an ocean bottom cable with integrated seismic sensors and electrical and/or optical wiring from the seismic sensors to the sea level where the seismic data is recorded. The seismic signals are generated by a seismic source deployed and towed by a source vessel. During data recording the cable is normally attached to a recording vessel or the cable deploying vessel. In the last couple of years a slightly different approach has been in use whereby the separate cable deploying vessel has been replaced with a recording buoy that also provides the cable with electrical power generated from either a diesel generator or from batteries located in the buoy. All or part of the recorded data is then transmitted via a radio link from the buoy to either the source vessel or the cable deploying vessel.

US patent application 2013/0058192 to Gateman et al. discloses an ocean bottom seismic cable with autonomous node capsules that are inserted into corresponding casings mounted along the OBC cable. In this application, the OBC(s) is/are deployed from a vessel, and thus subject to vertical forces caused by several nodes, each having negative buoyancy, suspended from the vessel. As the nodes are disposed at regular intervals along the OBC, the vertical forces increase with the depth to the seafloor. In addition, an OBC suspended from a vessel is subject to horizontal forces from underwater currents. As the depth increases, these forces are likely to cause deviations from a desired path on the seafloor.

The second method that is used is to deploy and recover autonomous seismic data recording nodes to and from the ocean bottom is by using a remotely operated vehicle or by simply dropping the seismic nodes in the sea and then let them slowly descend to the ocean bottom. In the latter case the seismic nodes are recovered by a vessel by transmitting a signal that triggers a mechanism in each of the seismic nodes that activates its floating device or releases the seismic node from an anchorage weight such that the seismic node can slowly float up to the sea level by itself.

The seismic data recorders can also be placed directly on to the ocean bottom by a variety of other mechanisms, including by the use of one or more of Autonomous Underwater Vehicles (AUVs). In either method, the data recorders can be discrete, autonomous units (no direct connection to other nodes or to the marine vessel) where data is stored and recorded or integrally linked (via communications and/or power) via wire or wireless links (such as acoustic, electromagnetic, or optical links).

US 2005/0246137 illustrates a method and system for acquiring seismic data without the need for wire line telemetry or radio-telemetry components or radio initiation. A plurality of individual wireless seismic data acquisition units are used wherein the individual data acquisition units may function as data sensor recorders and/or as source-event recorders. Each data acquisition unit records an

With the present method, a vessel needs to deploy the seismic nodes, and after the seismic data is recorded retrieve the nodes for further usage. In changing marine environments and due to different weather conditions, this cannot always be optimally scheduled. During a typical data acquisition program, the seismic nodes are placed underwater for a long duration, which could be several days, weeks or months at a time. In order to perform such a seismic survey, an array of seismic nodes is deployed on the seafloor. The array may be arranged as a rectangular grid with a seismic node at each crossing. Some times an irregular pattern maybe also be used. Typical distances are between 25 and 400 meters between adjacent nodes along a line and 100 to 800 meters between the lines. After the nodes are deployed, a source vessel towing acoustic sources fires a series of shots at known positions. The seismic response signals from each shot are detected at each node of the array. Each node may perform some signal processing. When the desired shots are performed, the nodes are retrieved, data harvested, and nodes turned around and stored for deployment in the next survey.

In US Patent Application No. 2019067980 there is described embodiments of systems and methods for inductively powering seismic sensor nodes. This may be an inductive battery including a battery cell configured to store charge for use by an external device. The inductive battery may also include a first inductive element coupled to the battery cell, the first inductive element configured to receive current from the battery cell and emit a responsive magnetic field for powering an external device through inductance. In an embodiment the external device is a seismic sensor node.

US Patent Application No. 2015316675 describes a system and method for monitoring a reservoir underwater. The system includes plural nodes, each having a seismic sensor for detecting seismic waves; a remote operated vehicle (ROV) configured to deploy or retrieve the plural nodes to seabed; and an autonomous underwater vehicle (AUV) configured to monitor and exchange data with the plural nodes. At least one node of the plural nodes has a head that houses the seismic sensor and the head is configured to burrow in the seabed, up to a predetermined depth, and the head remains in electrical contact through a connector with a base of the at least one node.

Each node may be autonomous, i.e. remain incommunicado with the survey vessel for the duration of a survey. An autonomous seismic node comprises seismic sensors, a recorder, a memory for storing the seismic signals and a power source, e.g. a battery pack (as described above), to supply the node with power during the survey. After retrieval, the seismic data are transferred to the survey vessel for later analysis. Marine seismic exploration methods uses a seismic source which transmits a seismic signal, while a receiving device measures the amplitudes and arrival times of the seismic signals returned (reflected/refracted) by discontinuities in the sub surface. The discontinuities are formed by interfaces between layers having different elastic properties and are called seismic reflectors. The returned seismic signals are recorded by seismic sensors at the ocean bottom or near the sea level.

In a typical application the autonomous ocean bottom nodes are independent seismometers as they are self-contained units comprising a housing, frame, skeleton, or shell that includes various internal components such as one or more seismic sensors (e.g., geophone and hydrophone sensors), a data recording unit, a reference clock for time synchronization, and a power source. The power sources are typically battery-powered, and in some instances the batteries are rechargeable. In operation, the nodes remain on the seafloor for an extended period of time. Once the data recorders are retrieved, the data is downloaded and batteries may be replaced or recharged in preparation of the next deployment. Various designs of ocean bottom autonomous nodes are well known in the art, see, e.g., U.S. Pat. No. 9,523,780. Still further, the autonomous seismic nodes may be integrated with an AUV such that the AUV, at some point subsea, may either travel to or from the seabed at a predetermined position, see, e.g., U.S. Pat. No. 9,090,319. In general, the basic structure and operation of an autonomous seismic node and a seismic AUV is well known to those of ordinary skill.

The nodes may be deployed or planted one by one, e.g. by a Remotely Operated Vehicle (ROV), or they may be connected by an Ocean Bottom Cable (OBC), typically at intervals of 12.5, 25 or 50 meters. An OBC facilitates retrieval, as single, small nodes might otherwise be difficult to locate and collect.

US Patent Application No. 2018364385 is directed to a system to deploy seismic sensors in a marine environment. The system can for example include a seismic sensor transfer device to house and transport a plurality of seismic sensors (e.g. nodes). This can be deployed from a vessel. The system can include a propulsion system that can be part of, integrated with, or mechanically coupled to the seismic sensor transfer device. The propulsion system can receive an instruction and move, responsive to the instruction, the seismic sensor transfer device. The system can include an underwater vehicle, such as a remotely operated vehicle or an autonomous under water vehicle. The underwater vehicle can be separate from the seismic sensor transfer device. The underwater vehicle can transfer at least one of the plurality of seismic sensors from the seismic sensor transfer device to the underwater vehicle. The underwater vehicle can operate at a second speed different from a first speed at which the vessel operates. The underwater vehicle can place the at least one seismic sensor on a seabed.

The seismic sensor transfer device can include at least one of a container, a drone, a skid structure, a transfer skid, a basket, a rack, a magazine, or a tray. The seismic sensor transfer device can include a movable platform configured to facilitate transfer of the seismic sensor device.

US Patent Application No. 2018364386 describes a helical conveyor for underwater seismic exploration. The system can include a case having a cylindrical portion. A cap is positioned adjacent to a first end of the case. A conveyor having a helix structure is provided within the case. The conveyor can receive an ocean bottom seismometer, such as a seismic node at a first end of the conveyer and transport the node via the helix structure to a second end of the conveyor to place the unit on the seabed to acquire the seismic data. The system can include a propulsion system to receive an instruction and, responsive to the instruction, facilitate movement of the case. The method can include a control unit providing the instruction to the propulsion system. The control unit can provide the instruction via a wired or wireless transmission. The method can include a control unit providing the instruction to follow a position of an object through an aqueous medium. The method can include adjusting a fin of the case to control a direction of the movement of the case.

It is costly and time consuming to place seismic nodes at the ocean bottom, and the weather and/or seabed conditions and obstructions may restrict time available for data acquisition and this may result in enough power to run all the electronics and other problems such as positioning tolerance, poor coupling, loosing node etc.

### SUMMARY

The present invention has been conceived to remedy or at least alleviate the above stated problems of the prior art. In a first aspect of the invention, the nodes are stored in a modular container, the container being releasably connected to an ROV and comprises means for deploying nodes onto the seabed. The invention thus provides a module for deploying and retrieving seismic node devices that can deploy the nodes fast and efficient while ensuring that the nodes are located in predetermined positions.

In one aspect of the invention, the nodes are stored in a modular container, the container being releasably connected to the ROV and that the container comprises means for deploying nodes onto the seabed.

In one aspect of the invention, the container houses a revolver magazine in which the nodes are stored and that the container comprises means for turning the revolver magazine such that nodes can be aligned with exit openings for releasing the nodes onto the seabed.

In one aspect of the invention, the container houses a magazine in which the nodes are stored and attached together by means of a continuous mechanical stress member, and that the container comprises means for deploying the nodes and their attached stress member in a controlled manner such that nodes will land onto the seabed and the planned location.

In another aspect of the invention, a retriever module can be attached to the ROV, having means for connecting to the node-containing module.

In another aspect of the invention, the retriever module comprises a scoop for picking up modules from the seabed and loading the nodes into the node container.

In yet another aspect of the invention, the receiver module comprises means for reading a n identification label on the node and storing the data into a computer on the module.

The invention also includes a method for deploying nodes on the seabed, comprising the steps of
a. Recording the speed and direction and altitude and position of the ROV
b. Moving a node to the aft/end of the magazine, and
c. Releasing the node so it lands on the seabed at the intended location.

With the invention it is possible to deploy nodes faster and more efficient than has been possible. The modularity of the system ensures fast turnaround and loading and unloading of nodes to and from the modular container.

### BRIEF DESCRIPTION OF DRAWINGS

FIG. 1 shows an ROV to be used with the invention,

FIG. 2 also shows an ROV,

FIG. 3 shows a revolver module according to the invention,

FIG. 4 shows the revolver module from the reverse side,

FIG. 5 is a section drawn along line A-A on FIG. 3,

FIG. 6 shows a node retriever according to the invention,

FIG. 7 shows the node deployer from the reverse side, showing thrusters for propulsion internal parts,

FIG. 8 shows a detail of the retriever module,

FIG. 9 shows yet another detail of the retriever module,

FIG. 10 also shows a detail of the retriever module, with the revolver module attached,

FIG. 11 shows another detail of the retriever module, and

FIG. 12 shows a ROV deployer deployment and recovery on deck arrangement.

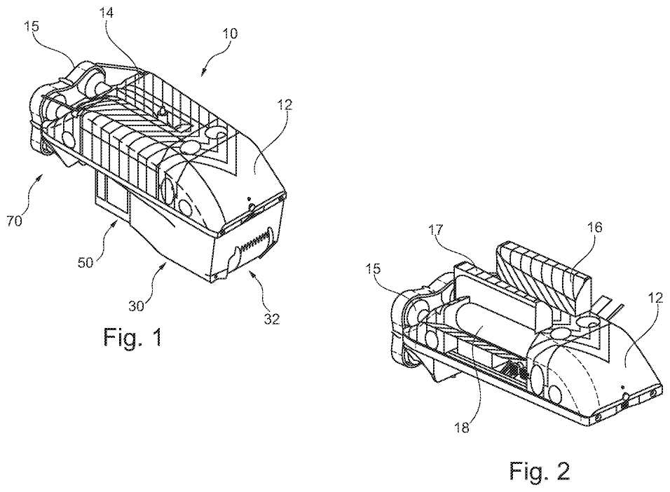

In FIG. 1 there is shown a ROV 10 having a front end 12 and a rear end 14. At the rear end of the ROV there is arranged thrusters 15 for propulsion. The ROV may be an autonomous ROV or be controlled using an umbilical, as is well known. In FIG. 1 there is also shown a node retriever module 30 and a node containing module 50 attached to the underside of the ROV. At the front of the retriever module is shown a scoop 32 which purpose will be described later. The node containing module also has means to enable nodes to be deployed onto the seabed.

FIG. 2 shows the ROV with side hatches 16, 17 open to show buoyancy tanks 18 that is part of a variable buoyancy system. Such system is used to trim the ROV to compensate for the variations in loads when deploying or retrieving modules.

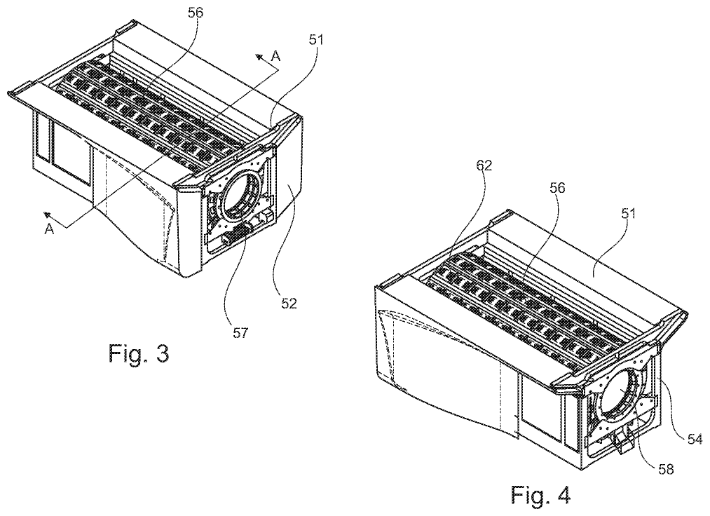

FIG. 3 shows a node module according to the invention being in the form of a container 50 with a housing 51 for structural strength. The module comprises a front end 52 and a rear end 54. It also has means (not shown) for coupling the module to the ROV. Inside the module there is a magazine 56 for storing nodes. In the preferred embodiment the magazine is a revolver magazine that has compartments for storing nodes. Several nodes can be stored end to end along its length and the revolver can be rotated to bring a compartment in line with an exit or entry opening. In FIG. 3 there is shown an entry opening 57 to receive nodes from the retrieval module. This will be explained in more detail later. In FIG. 4 there is shown the exit opening 58 for deploying nodes onto the seabed.

The magazine facilitates loading and unloading of a large number of nodes. The nodes are loaded into the magazine on a vessel or prepared beforehand on land. The modularity allows for fast exchange of modules on the vessel deck (ref. FIG. 11).

The magazine can have a length sufficient to store many nodes end to end. It also preferably be equipped with a transport system for moving nodes towards the exit 58. This will be explained in more detail later.

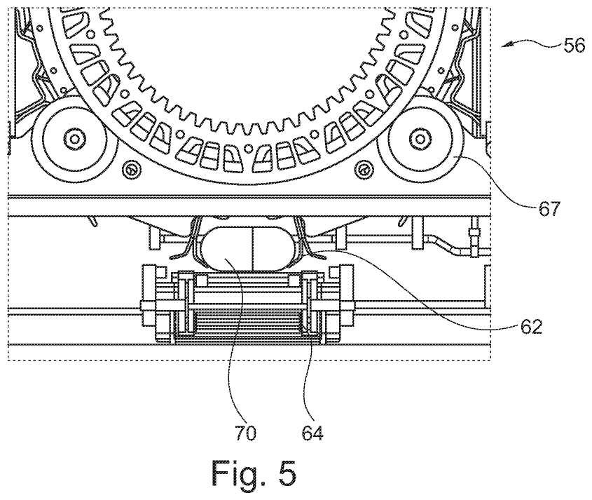

In FIG. 5 there is shown the structure of the revolver magazine 56. The magazine rotates on rollers 67 driven by motors (not shown). The magazine has a generally circular shape with compartments 62 arranged along its periphery. The nodes 70 are stored end to end in the compartments 62. A transport system 64 moves individual nodes along the length of the compartments 62. This transport system may be a belt such as a ladder wire-belt with side support. When the drum is turning the node 70 will lift and slide on the belt. The drum motor will have enough torque rotate the drum with the nodes sliding on the belt. To avoid the sides of the compartments 62 touching the belt the revolver magazine may be rolling on a cam profile to slightly lift the drum between each rows.

A second alternative is to use a belt with brushes to push the nodes. When rotating the drum the fingers bend away. The fingers will also bend away when the node is transported at end of the row.

Buoyancy tanks 65 are located inside the module. The purpose of these are to compensate for the weight of the module in water. Preferably the buoyancy is arranged so that the module is neutral when half full of nodes.

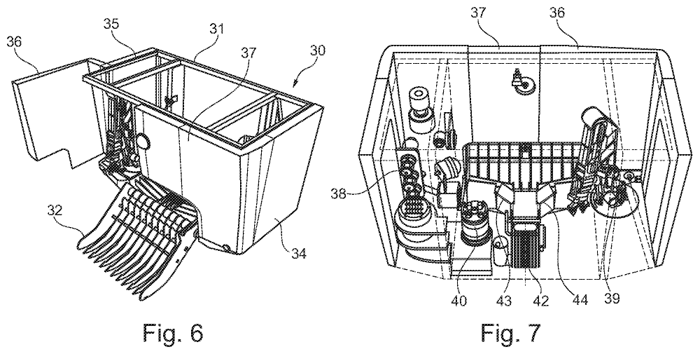

FIG. 6 shows the retriever module 32. It comprises a frame 31 open at the top, sides 34, 35 and a front that has doors 36, 37 that can open to give access to the interior. In the front there is a scoop 32 for retrieving nodes lying on the seabed. FIG. 7 shows the interior of the retriever module. It has an observer system 38 with lights and camera to show an operator the inside of the module during observations. There is also a manipulator 39 for manual handling of nodes if necessary. An electronics unit controls the operations inside the module. A conveyor belt 42 or other transport means can move the nodes that have been scooped up from the seabed towards the deployer module.

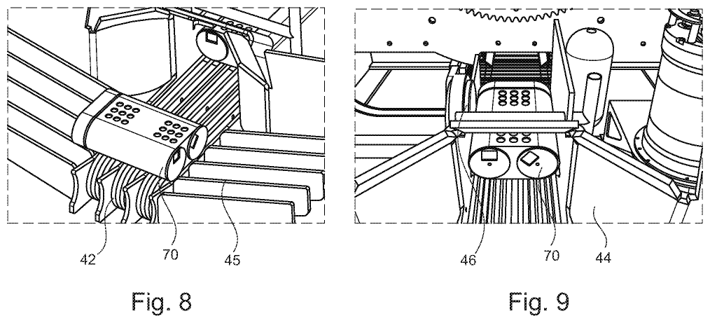

The belt 42 may consists of several individual belts independently controlled. This enables the nodes 70 to be reoriented if they are scooped up with an incorrect orientation (as shown in FIG. 8). Angled guides 45 ensures that a node will slide down towards the belt 42. Angled deflectors 42, 44 is intended for guiding the nodes towards the belt(s). If the nodes still are not in the correct position the manipulator may be used to lift and reorient the nodes. The nodes may be equipped with labels and a reader 46 is arranged near the belt to read the label and thus identify the node being picked up from the seabed.

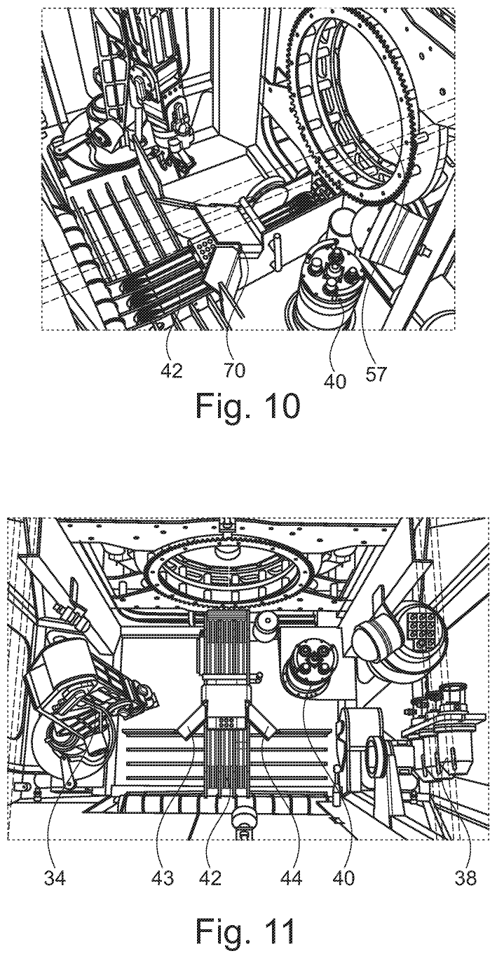

FIGS. 10 and 11 show yet more detail of the retriever module. The nodes being picked up by the scoop 32 will be loaded onto the belt and moved towards the entrance 57 of the node module 50. The node module may have transport means for moving the loaded nodes towards the front end of the node module. When the magazine is full, the drum can be rotated to align empty compartments with the entrance 57 for loading yet more nodules. Preferably the drum is rotated by around 180° at each step to balance the loads.

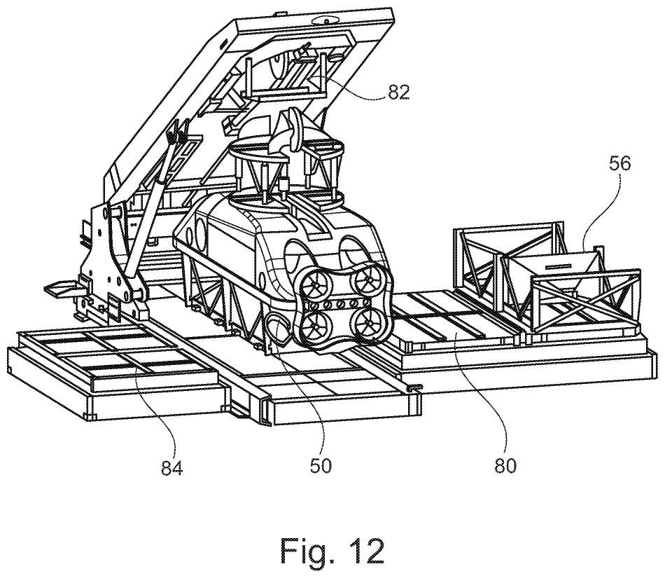

FIG. 12 shows a launch and recovery system for the use of exchanging modules and launching and loading the ROV. Node modules 50 are placed on a movable deck 80. When a ROV has been retrieved from the sea it is held by a crane in a correct position both horizontally and vertically to change out modules. The module 50′ on the ROV is released and when a new module 50 is moved towards the ROV the module 50 will push the old module 50′ out of the ROV and onto a stationary deck 84 and the new module 50 coupled to the ROV. The old module 50′ can now be filled with new nodes and made ready for another trip or, if the ROV has retrieved nodes that has recorded seismic activity the nodes will be taken out from the module and analyzed for seismic data.

With the invention a large number of nodes can quickly be placed on the seabed. Also the retrieval of nodes from the seabed can be done more efficiently and faster than hitherto has been the case.

Using the transport means in the node deployer module and coupled with information about the movements of the ROV, nodes can be positioned accurately on the seabed, that is at required spatial intervals. This is achieved by monitoring the speed and direction and altitude and position of the ROV and using the transport means on the node deployer to push the node out of the deployer at the correct time to ensure accurate landing position.

To more accurately positioning individual nodes onto the seabed, information about the position and speed of the ROV is used to calculate when a node should be dropped off. Then the transporting means inside the node module is operated to deploy a node onto the seabed. During this operation the coordinates of the drop-off location is recorded and stored in a computer. This will more quickly enable nodes to be retrieved again.

The retriever module comprises means to read off the identifying label on the node(s). This information is also stored in a computer and may be used when performing the calculations for the seismic data map(s). The retriever module may also have means for cleaning the node(s) (not shown).

1. A system for deploying and retrieving seismic nodes from the seabed using an ROV, wherein the nodes are stored in a modular container, the modular container being releasably connected to the ROV and that the modular container is configured to deploy nodes onto the seabed.

2. The system according to claim 1, wherein the modular container houses a revolver magazine in which the nodes are stored.

3. The system according to claim 2, wherein the modular container comprises means for turning the revolver magazine.

4. The system according to claim 2, wherein the modular container comprises openings for entering and/or exiting nodes.

5. The system according to claim 2, wherein the modular container comprises buoyancy tanks.

6. The system according to claim 1, wherein a retriever module is configured to be attached to the ROV, wherein the retriever module comprises means for connecting to the modular container.

7. The system according to claim 6, wherein the retriever module comprises a scoop that is configured to pick up modules from the seabed.

8. The system according to claim 6, wherein the retriever module comprises means for moving the nodes into the modular container.

9. The system according to claim 6, wherein the retriever module comprises means for reorienting the nodes before loading them into the modular container.

10. The system according to claim 6, wherein the retriever module comprises means for reading a label on the node containing node identification.

11. The system according to claim 6, wherein the retriever module comprises means to clean the node.

12. The system according to claim 10, wherein the node identification is stored together with data on pickup location.

13. A method for deploying seismic nodes in an array on the seabed, using a node deployment system according to claim 1, comprising the following operations:
recording the speed and direction and altitude and position of the ROV,
moving a node to an end of the magazine, and
releasing the node when data indicates that the ROV has reached a correct position.

14. The method according to claim 13, wherein identifying labels on the nodes are read during retrieval and stored with location data.
